(19) United States
(12) Patent Application Publication
(10) Pub. No.: US 2026/0342412 A1
(43) Pub. Date: Oct. 29, 2026

(54) METHODS, DEVICES, AND MEDIUM FOR COMMUNICATION

(71) Applicant: NEC Corporation, Tokyo (JP)

(72) Inventors: Gang WANG, Beijing (CN); Peng GUAN, Beijing (CN)

(73) Assignee: NEC Corporation, Tokyo (JP)

(21) Appl. No.: 19/113,572

(22) PCT Filed: Sep. 23, 2022
(86) PCT No.: PCT/CN2022/121106

§ 371 Date: Mar. 20, 2025

(51) Int. Cl. H04B 7/06

(52) U.S. Cl. CPC H04B 7/0695

(57) ABSTRACT

A method for communication, comprises: determining, at a terminal device, a configured set of beams and one or more lists, a list of the one or more lists comprising one or more sets of beams being subsets of the configured set of beams, the one or more sets of beams and/or the configured set of beams being configured for an Artificial Intelligence/Machine Learning (AI/ML) operation; selecting a set of beams from the one or more sets of beams; and transmitting, to the network device, a beam report comprising indication information and beam information corresponding to the selected set of beams, the indication information comprising at least one of: a list identifier (ID), a set ID or a beam ID corresponding to the selected set of beams, the beam information comprising at least one of: a beam ID or a quality metric corresponding to the selected set of beams.

### FIELD

Example embodiments of the present disclosure generally relate to the field of communication techniques and in particular, to methods, devices, and a computer readable medium for communication.

### BACKGROUND

In 3GPP (The Third Generation Partnership Project) Release 18 (also referred to as “Rel-18”), Artificial Intelligence/Machine Learning (AI/ML) model is introduced for beam management (BM) in communication systems. For AI/ML model operation (for example, model inference), the traditional approach is to configure a terminal device by a network device with a beam report corresponding to one or more sets of channel state information-reference signal (CSI-RS)/synchronization signal block (SSB) resources. Each resource corresponds to a specific beam. Assuming one CSI-RS/SSB resource set is configured for the beam report, the set of CSI-RS/SSB resource can be regarded as set A. The terminal device needs to calculate the layer 1-reference signal received power (L1-RSRP) corresponding to all beams in set A and select top K (K is an integer which is less than or equal to the number of beams in set A) beams (i.e., having the largest L1-RSRP) as the beams to report to the network device, then the terminal device transmits to the network device the generated beam report associated with the selected beams in allocated physical uplink control channel (PUCCH)/physical uplink shared channel (PUSCH) resources.

The size of set A may be large, which results in large computation and reporting overhead when the terminal device calculates the L1-RSRP corresponding to all beams in set A. Therefore, beam pattern of set B is considered. Set B is a subset of set A, and can be fixed beam pattern or random beam pattern. Each set B may correspond to a specific AI/ML model at the network device.

In order to assist selection of set B from set A, a set C which is a subset of set A may be introduced. However, issues like how to select the set B, what information corresponding to the selected set B needs to be reported and how to report such information still need to be considered.

### SUMMARY

In general, example embodiments of the present disclosure provide methods, devices and a computer storage medium for communication.

In a first aspect, there is provided a method for communication. The method comprises: determining, at a terminal device, a configured set of beams and one or more lists, a list of the one or more lists comprising one or more sets of beams being subsets of the configured set of beams, the one or more sets of beams and/or the configured set of beams being configured for an Artificial Intelligence/Machine Learning (AI/ML) operation; selecting a set of beams from the one or more sets of beams; and transmitting, to the network device, a beam report comprising indication information and beam information corresponding to the selected set of beams, the indication information comprising at least one of: a list identifier (ID), a set ID or a beam ID corresponding to the selected set of beams, the beam information comprising at least one of: a beam ID or a quality metric corresponding to the selected set of beams.

In a second aspect, there is provided a method for communication. The method comprises: transmitting, at a network device to a terminal device, configuration information indicating a configured set of beams and one or more lists, a list of the one or more lists comprising one or more sets of beams being subsets of the configured set of beams, the one or more sets of beams and/or the configured set of beams being configured at the terminal device for an AI/ML operation; and receiving, from the terminal device, a beam report comprising indication information and beam information associated with a set of beams selected from the one or more sets of beams, the indication information comprising at least one of: a list ID, a set ID or a beam ID associated with the selected set of beams.

In a third aspect, there is provided a terminal device. The terminal device comprises a processor and a memory. The memory is coupled to the processor and stores computer program codes thereon. The memory and the computer program codes are configured to, with the processor, cause the terminal device to perform the method according to the first aspect above.

In a fourth aspect, there is provided a network device. The network device comprises a processor and a memory. The memory is coupled to the processor and stores computer program codes thereon. The memory and the computer program codes are configured to, with the processor, cause the network device to perform the method according to the second aspect above.

In a fifth aspect, there is provided a computer readable medium having instructions stored thereon, the instructions, when executed on at least one processor, causing the at least one processor to carry out the method according to any of the first and second aspects above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a schematic chart illustrating the relationship between set A and set C in accordance with some embodiments of the present disclosure;

FIG. 3 illustrates an example signaling chart illustrating a communication process in accordance with some example embodiments of the present disclosure;

FIG. 4 illustrates another example signaling chart illustrating another communication process in accordance with some example embodiments of the present disclosure;

FIG. 5A illustrates a schematic chart illustrating the selection of set B from set C in accordance with some embodiments of the present disclosure;

FIG. 5B illustrates a schematic chart illustrating the selection of set B from set C in accordance with some embodiments of the present disclosure;

FIG. 5C illustrates a schematic chart illustrating the selection of set B from set C in accordance with some embodiments of the present disclosure;

FIG. 6A illustrates a schematic chart illustrating configuration of uplink control information (UCI) in accordance with some embodiments of the present disclosure;

FIG. 6B illustrates a schematic chart illustrating configuration of UCI in accordance with some embodiments of the present disclosure;

FIG. 7 illustrates a flowchart of an example method implemented at a terminal device in accordance with some embodiments of the present disclosure;

FIG. 8 illustrates a flowchart of an example method implemented at a network device in accordance with some embodiments of the present disclosure;

FIG. 9 illustrates a simplified block diagram of a device that is suitable for implementing embodiments of the present disclosure.

Throughout the drawings, the same or similar reference numerals represent the same or similar element.

Through this document, the terms defined below may be referenced.
3GPP 3rd generation partnership project
NR New Radio Access
NW Network
gNB the next Generation Node B
UE User Equipment
BM Beam Management
CSI Channel State Information
AI/ML Artificial Intelligence/Machine Learning
CSI-RS Channel State Information Reference Signal
SSB Synchronization Signal and PBCH Block
QCL Quasi-co location
RRC Radio Resource Control
MAC-CE Media Access Control-Control Element
DCI Downlink Control Information
CRI CSI-RS Resource Indicator
RSRP Reference Signal Receiving Quality
SSBRI SSB Resource Indicator
RSRQ Reference Signal Receiving Quality
SINR Signal to Interference plus Noise Ratio
ID Identity or Index
RMS Root Mean Square
SD Standard Deviation
MSE Mean Square Error
RMSE Root Mean Square Error

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In some communication systems, AI/ML model(s) is(/are) used for beam management. For example, in the AI/ML model inference scenario, AI/ML model learns “(historical) experience”. The “experience” consists of tens of thousands of training data. The training data has covered all possible realities as much as possible. Therefore, selection of set B from set A is very important. However, due to the variability and randomness of the real environment, AI/ML model is still unable to deal with some “accidental” cases.

Specifically, as mentioned above, set B can be fixed beam pattern or random beam pattern. Fixed beam pattern may be easy to obtain optimal or better performance of model inference, while may result in poor generalization performance. Random beam pattern has high generalization performance, while may be difficult to obtain optimal or better performance of model inference. To solve this problem, a set C, which is a subset of set A and comprises one or more set Bs, is introduced to achieve stable and acceptable model inference performance. To reduce overhead caused by UCI reporting, selection of set B from set C is preferably performed at the terminal device. However, issues like how to select set B from set C, what information corresponding to the selected set B needs to be reported to the network device and how to report such information still need to be studied.

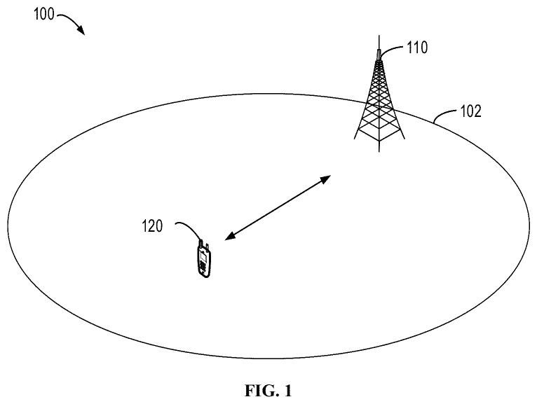

FIG. 1 illustrates an example communication system 100 in which some embodiments of the present disclosure can be implemented. The communication system 100, which is a part of a communication network, includes a network device 110 and a terminal device 120.

The network device 110 can provide services to the terminal device 120, and the network device 110 and the terminal device 120 may communicate data and control information with each other. In some embodiments, the network device 110 and the terminal device 120 may communicate with direct links/channels.

In the system 100, a link from the network devices 110 to the terminal device 120 is referred to as a downlink (DL), while a link from the terminal device 120 to the network devices 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1, the network device 110 provides one serving cell 102, and the terminal device 120 camps on the serving cell 102. In some embodiments, the network device 110 can provide multiple serving cells. It is to be understood that the number of serving cell(s) shown in FIG. 1 is for illustrative purposes only without suggesting any limitation.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the number of devices and their connection relationships and types shown in FIG. 1 are for illustrative purposes only without suggesting any limitation.

The communication system 100 may comprise any suitable number of devices adapted for implementing embodiments of the present disclosure.

It is to be noted that:

The term “Beam” in this disclosure refers to, for example, reference signal (RS, e.g., CSI-RS or SSB) or RS resource.

The term “QCL-TypeD” in this disclosure refers to, for example, Spatial Rx parameters.

The term “Beam of a target signal” in this disclosure refers to, for example, QCL-TypeD RS of the target signal.

The term “Beam ID” in this disclosure refers to, for example, CSI-RS/SSB resource ID, CSI-RS/SSB Resource Indicator (CRI) or SS/PBCH Block Resource Indicator (SSBRI).

The term “Bitwidth” (or UCI payload size) for target information in this disclosure refers to, for example, payload size occupied by the target information in UCI, or payload size or bitwidth of the target information field.

It is also to be noted that, in this document, Layer 1-Reference Signal Received Power (L1-RSRP) can be replaced with Layer 1-Signal to Interference plus Noise Ratio (L1-SINR), RSRP, SINR, Reference Signal Received Quality (RSRQ) or Carrier to Interference-plus-Noise Ratio (CINR).

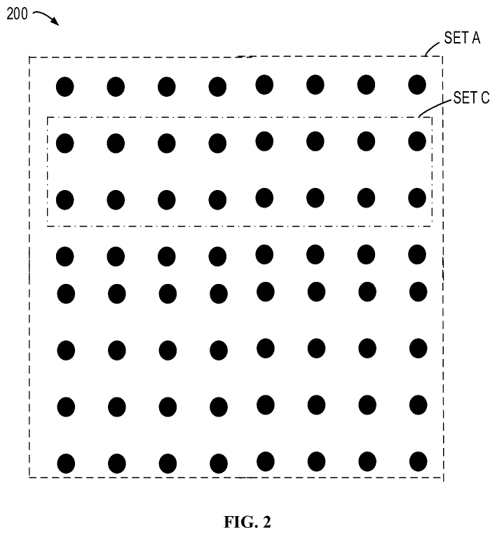

FIG. 2 illustrates a schematic chart 200 illustrating the relationship between set A and set C in accordance with some embodiments of the present disclosure. Only for the purpose of discussion, the schematic chart 200 will be described with reference to FIG. 1. The schematic chart 200 may involve the terminal device 120 and the network device 110.

As illustrated in FIG. 2, each solid black circle denotes a beam as defined above. An AI/ML model is deployed at the network device 110 as well as the set A. “set A” denotes a set of RSs (also referred to as “a set of beams” hereafter) deployed at the network device 110, and it comprises 64 beams in total. Further, a set C denotes another set of beams which is to be used in field measurements at the terminal device 120 for AI/ML model operations such as inference. In the example illustrated in FIG. 2, set B comprises 16 beams out of the set A, and is a subset of set A. In beam management scenarios, the network device 110 may transmit the set C to the terminal device 120 to obtain field/actual measurements. As mentioned above, such field measurements are used to select the top K beams out of the set A to improve communication quality and system performance.

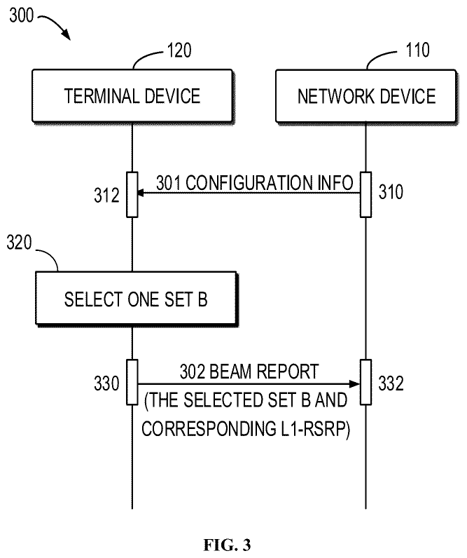

FIG. 3 illustrates an example signaling chart illustrating a communication process 300 in accordance with some example embodiments of the present disclosure. Only for the purpose of discussion, the communication process 300 will be described with reference to FIG. 1. The communication process 300 may involve the terminal device 120 and the network device 110.

In some example embodiments, the network device 110 transmits to the terminal device 120 configuration information indicating a first set of beams and one or more lists. Each list of the one or more lists comprises one or more second sets of beams. Each set of beams amongst the one or more second sets of beams is a subset of the first set of beams. The one or more second sets of beams and/or the first set of beams is to be configured at the terminal device 120 for an AI/ML model operation. On the other side of communication, the terminal device 120 receives the configuration information, and determines the first set of beams and the one or more lists.

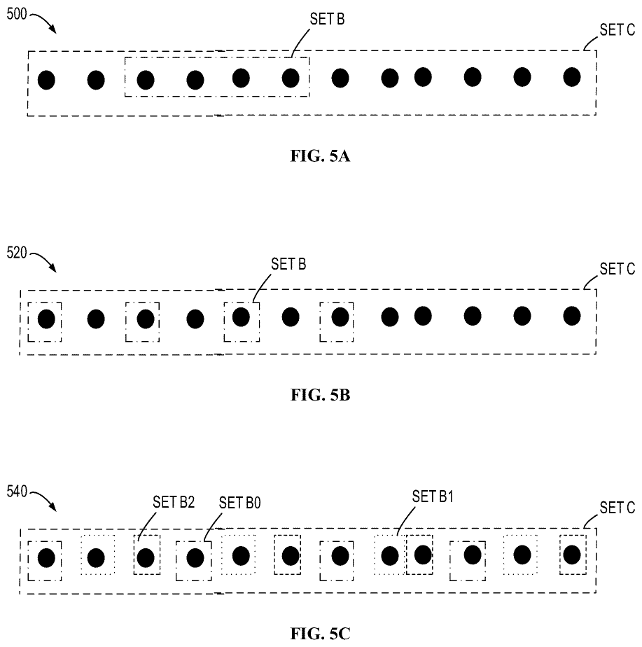

For example, the network device 110 is deployed with at least one AI/ML model. The network device 110 transmits 310 to the terminal device 120 configuration information 301, as illustrated in FIG. 3. The configuration information 301 includes triggering a beam report. The configuration information 301 also comprises configuration information of the following:
A set of beam measurement reference signals (RSs, also called as set C for short) associated with the beam report. Each RS in the set C corresponds to a specific downlink transmission (DL Tx) beam. The set of beam measurement RSs (that is, set C) refers to a set of CSI-RS/SSB resources.
One or more lists, each list comprises one or more set Bs associated with the beam report or the set C. Alternatively, multiple set Bs associated with the beam report or the set C. Each set B refers to a set of beam ID (e.g., CSI-RS/SSB resource ID, CRI/SSBRI corresponding to the set C). In other words, the set B can be regarded as a subset of the set C. The one or more set Bs may be divided into multiple lists (or Groups). Each list may correspond to a specific number of beams in set B. The terminal device 120 can be configured with the one or more set Bs in several ways, which will be described in detail with reference to FIGS. 5A-5C.

The terminal device 120 can be configured with the one or more set Bs in several ways. In one example, each set B may refer to a set of beam ID (e.g., CSI-RS/SSB resource ID, CRI/SSBRI in the set C). And each set B may be configured with a specific or dedicated indicator or ID (e.g., 0, 1, 2), which may be called as “set ID”. In another example, the terminal device 120 may need to determine the set B based on some configured rules, for example, those illustrated in FIGS. 5A-5C. In this case, each selected set B may also be configured with a specific ID. The specific ID configured for set B can be called as “set ID” in this document for short. In some examples, the lower the set ID, the better performance of model inference corresponding to the set B (in offline).

On the other side of communication, the terminal device 120 receives the configuration information 301, and determines 312 the set C and the one or more lists. Each list of the one or more lists comprises one or more set Bs, as illustrated in FIG. 3.

Then, the terminal device 120 selects a set B from the one or more set Bs.

For example, the terminal device 120 may select 320 one set B from the one or more set Bs, as illustrated in FIG. 3.

Then, the terminal device 120 transmits to the network device 110 a beam report comprising indication information and beam information corresponding to the selected set B. The indication information comprises at least one of: a list ID, a set ID or a beam ID corresponding to the selected set B. The beam information comprises at least one of: a beam ID or a quality metric corresponding to the selected set B. On the other side of communication, the network device 110 receives from the terminal device 120 the beam report comprising the indication information and the beam information associated with the selected set B.

For example, the terminal device 120 transmits 330 to the network device 110 a beam report 302 comprising indication information and beam information corresponding to the selected set B, as illustrated in FIG. 3. The indication information comprises at least one of: a list ID, a set ID or a beam ID corresponding to the selected set B. The beam information comprises at least one of: a beam ID or a quality metric corresponding to the selected set B. In other words, the terminal device 120 reports the beam information in the selected set B to the network device 110. The beam information may comprise the selected set B and corresponding L1-RSRP values, which is a quality metric reflecting the communication quality or performance between the network device 110 and the terminal device 120.

On the other side of communication, the network device 110 receives 332 from the terminal device 120 the beam report 302 comprising the indication information and the beam information associated with the selected set B.

In some example embodiments, the quality metric refers to any of Layer 1-Reference Signal Received Power (L1-RSRP), Layer 1-Signal to Interference plus Noise Ratio (L1-SINR), RSRP, SINR, Reference Signal Received Quality (RSRQ) or Carrier to Interference-plus-Noise Ratio (CINR).

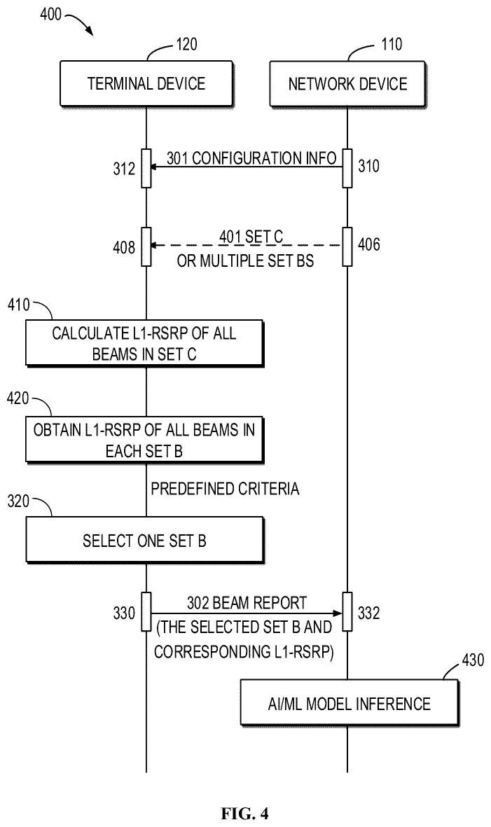

FIG. 4 illustrates another example signaling chart illustrating another communication process 400 in accordance with some example embodiments of the present disclosure. Only for the purpose of discussion, the communication process 400 will be described with reference to FIGS. 1 and 3. The communication process 400 may involve the terminal device 120 and the network device 110. For operations similar to those in the example as illustrated in FIG. 3, similar reference signs are used, and detailed description are omitted since they can refer to the description of the example as illustrated in FIG. 3.

In some example embodiments, the network device 110 further transmits 406 the set C and multiple set Bs to the terminal device 120. Set C is a set of beam measurement reference signals associated with the beam report. The multiple set Bs are associated with the beam report or the set C. On the other side of communication, the terminal device 120 receives 408 all reference signals (RSs) in set C (alternatively, multiple set Bs) from the network device 110.

In some example embodiments, the terminal device 120 selects the selected set of beams from the one or more set of beams by: first determining one or more sets of quality metrics corresponding to the one or more set of beams; and then selecting the selected set of beams based on the one or more sets of quality metrics and at least one criterion.

For example, after determining 312 the configuration information 301 transmitted from the network device 110, the terminal device 120 calculates 410 the L1-RSRP of all beams in set C, as illustrated in FIG. 4. Here, L1-RSRP represents a quality metric reflecting the communication quality or performance between the network device 110 and the terminal device 120.

Since each set B is a subset of set C, after the L1-RSRP of all beams in set C is calculated 420, the terminal device 120 obtains 420 the L1-RSRP of all beams in each set B accordingly.

Based on the obtained L1-RSRPs corresponding to all set Bs, the terminal device 120 selects 320 or determines one set B according to some specific or predefined criteria.

In some example embodiments, the at least one criterion comprises at least one of the following first type of criteria:
a maximum of a set of quality metrics corresponding to the selected set of beams is maximum amongst the one or more sets of beams;
a minimum of the set of quality metrics corresponding to the selected set of beams is minimum amongst the one or more sets of beams;
a mean or a root mean square of the set of quality metrics corresponding to the selected set of beams is maximum or minimum amongst the one or more sets of beams;
a variance or a standard deviation of the set of quality metrics corresponding to the selected set of beams is minimum or maximum amongst the one or more sets of beams;
an error between the set of quality metrics and a set of reference quality metrics corresponding to the selected set of beams is minimum amongst the one or more sets of beams;
the set ID or the list ID corresponding to the selected set of beams is minimum or maximum amongst the one or more sets of beams; or
the number of beams in the selected set of beams is minimum or maximum amongst the one or more sets of beams.

For example, from the set C (or, in other words, one or more set Bs), the terminal device 120 may select (or determine) a set B based on some predefined criteria according to a predefined selection strategy.

For example, for all configured set Bs, the terminal device 120 selects only one set B according to at least one of first type of predefined criteria (shown as follows). It means that the terminal device 120 needs to process all set Bs or calculate the potential metrics (e.g., mean, variance, error) corresponding to all set Bs.
One or more predefined L1-RSRPs (e.g., the smallest L1-RSRP, the largest L1-RSRP) corresponding to the set B is maximum, or minimum.
The mean or RMS of the L1-RSRPs corresponding to the set B is maximum, or minimum.
The variance or SD of the L1-RSRPs corresponding to the set B is minimum, or maximum.
The error (e.g., MSE, RMSE) between all L1-RSRPs and reference RSRPs corresponding to the set B is minimum.
The set ID or list ID corresponding to the set B is minimum, or maximum.
The number of beams in the set B is minimum, or maximum.

In some example embodiments, the at least one criterion comprises at least one of the following second type of criteria:
a maximum of a set of quality metrics corresponding to the selected set of beams is greater than or equal to a first threshold;
a minimum of the set of quality metrics corresponding to the selected set of beams is less than or equal to a second threshold;
a mean or a root mean square of the set of quality metrics corresponding to the selected set of beams is greater than or equal to a third threshold, or less than or equal to a fourth threshold;
a variance or a standard deviation of the set of quality metrics corresponding to the selected set of beams is less than or equal to a fifth threshold, or greater than or equal to a sixth threshold; or
an error between the set of quality metrics and a set of reference quality metrics corresponding to the selected set of beams is less than or equal to a seventh threshold.

For example, the terminal device 120 can process the set B (i.e., determine whether the set B satisfies at least one of second type of predefined criteria) in the configured set Bs sequentially (or one by one) in a predefined order. The second type of predefined criteria may be at least one of the following:
One or more predefined L1-RSRPs (e.g., the smallest L1-RSRP, the largest L1-RSRP) of the L1-RSRPs are larger than or equal to a threshold, and (or) less than or equal to another threshold.
The mean or RMS of all L1-RSRPs is are larger than or equal to a threshold, and (or) less than or equal to another threshold.
The variance or SD of all L1-RSRPs is less than or equal to a threshold, and (or) larger than or equal to another threshold.
The error (e.g., MSE, RMSE) between all L1-RSRPs and reference RSRPs is less than or equal to a threshold.

In some example embodiments, the selected set B is selected by the terminal device 120 by determining, based on the one or more sets of quality metrics and the second type of criteria whether a set of beams among the one or more sets of beams is to be selected as the selected set of beams sequentially in a predefined order.

For example, in order to select the selected set B from the one or more set Bs, the terminal device 120 may determine, based on one or more sets of L1-RSRPs and the second type of criteria, whether a set B among the one or more set Bs is to be selected as the selected set B sequentially (or one by one) in a predefined order.

Additionally, in some example embodiments, the predefined order is at least one of:
an ascending order or a descending order of set ID corresponding to the one or more sets of beams;
an ascending order or a descending order of list ID corresponding to the one or more sets of beams; or
an ascending order or a descending order of the number of beams in the one or more sets of beams.

For example, the predefined order can be at least one of the following:
Ascending (or descending) order of set ID corresponding to the set B.
Ascending (or descending) order of list ID corresponding to the set B.
Ascending (or descending) order of the number of beams in the set B.

For example, if the first set B satisfies the second type of predefined criteria, the terminal device 120 may stop processing the other set Bs and directly select the first set B, i.e., the first set B is used as the final selected set B. Otherwise, the terminal device 120 needs to process the second set B, etc.

In some example embodiments, after receiving 332 the beam report 302 from the terminal device 120, the network device 110 performs 430 AI/ML model inference by using the beam information of the selected set B in the received beam report 302, as illustrated in FIG. 4. It is to be noted and understood that, “model inference” is described here just as an example; the AI/ML operation(s) performed by the network device 110 is not limited to model inference, but should include any other operation(s) relating to AI/ML model(s) deployed at the network device 110.

FIG. 5A illustrates a schematic chart 500 illustrating the selection of set B from set C in accordance with some embodiments of the present disclosure. Only for the purpose of discussion, the schematic chart 500 will be described with reference to FIG. 2.

As illustrated in FIG. 5A, for each set B, a start location (e.g., 0, 1, 2) and a size of the set B (i.e., number of beams in the set B) in the set C are configured. For example, assuming the set C includes 16 beams (i.e., RSs). For the purpose of simplicity and illustration, only 12 beams are illustrated. The beams in the set C are arranged in ascending (or descending) order according to the RS resource IDs corresponding to the beams. Then, the terminal device 120 can determine the set B based on the configured start location (e.g., 2) and the size of the set B (e.g., 4), as illustrated in FIG. 5A.

FIG. 5B illustrates another schematic chart illustrating the selection of set B from set C in accordance with some embodiments of the present disclosure. Only for the purpose of discussion, the schematic chart 500 will be described with reference to FIG. 2.

As illustrated in FIG. 5B, for each set B, a stat location and a sampling interval are configured. For example, also assuming the set C includes 16 beams and only 12 beams are illustrated. Assuming the start location and the sampling interval are 0 and 2 respectively, then the selected set B comprises the beams which has a even index in the set C.

FIG. 5C illustrates another schematic chart illustrating the selection of set B from set C in accordance with some embodiments of the present disclosure. Only for the purpose of discussion, the schematic chart 500 will be described with reference to FIG. 2.

As illustrated in FIG. 5C, each set B is selected based on uniform sampling. For example, also assuming the set C includes 16 beams and only 12 beams are illustrated. The number of set Bs is configured. For example, assuming the number of set B is 3. In this case, the selected set BO comprises the beams which has an index of 3k (k is an integer) in the set C, the selected set B1 comprises the beams which has an index of 3k+1 in the set C, and the selected set B2 comprises the beams which has an index of 3k+2 in the set C.

Though in the example illustrated in FIG. 5C, beams in any two set Bs do not overlap with each other, in some other examples, beams in two set Bs may overlap with each other. For example, set Bs in FIGS. 5A and 5B may co-exist, and beams in the two set Bs partially overlap with each other.

In addition to set B, the terminal device 120 may be configured with one or more list of set Bs (called as “list” for short). Specifically, the list refers to a list, set or group of set Bs. Each list may be configured or associated with a specific or dedicated indicator or ID, which can be called as “list ID” in this document. Different lists may correspond to different numbers of beams in the set Bs. In some examples, the lower the list ID, the smaller the number of beams in the set B in the corresponding list. Furthermore, the lower list ID may be prioritized due to the less overhead of beam reporting.

Different set Bs (i.e., beam patterns of the set B) may correspond to different AI/ML models. Accordingly, each set B may correspond to a specific or dedicated AI/ML model, while each AI/ML model may be configured or assigned a specific or dedicated indicator or ID (called as “model ID” for short). Therefore, set ID can be equivalent to model ID. Further, since the list includes a list of set Bs, each list may correspond to or include a group of AI/ML models. Accordingly, list ID can be equivalent to a specific or dedicated indicator or ID associated with the group of AI/ML models (called as “Model group ID”).

Further, since the list includes a list of set Bs, each list may correspond to or include a group of AI/ML models. Accordingly, list ID can be equivalent to a specific or dedicated indicator or ID associated with the group of AI/ML models (called as “model group ID”).

In summary, set ID can be equivalent to model ID, list ID can be equivalent to model group ID and set ID can be equivalent to model ID, and list ID can be equivalent to model ID.

In some example embodiments, in response to determining that none of the one or more sets of beams satisfies the second type of criteria, reporting, to the network device, beam information corresponding to the configured set of beams.

For example, if the terminal device 120 determines that none of the one or more set Bs satisfies any of the second type of criteria, then the terminal device 120 may report to the network device 110 beam information corresponding to the set C. Alternatively, if no set B satisfies the second type of criteria, the terminal device 120 may prefer to select the set B satisfying at least one of the first type of predefined criteria.

Additionally, in this case, in some example embodiments, the beam report further comprises an indication indicating whether none of the one or more sets of beams satisfies the second type of criteria.

For example, the terminal device 120 may report 330 the beam report 302 which further comprises an indication (called as “second indication” indicating whether none of the one or more set Bs satisfies the second type of criteria. The second indication may be defined as 1-bit, and value “1” indicates that none of the one or more set Bs satisfies the second type of criteria, value “0” indicates the contrary (that is, at least one set B satisfies the second type of criteria).

Additionally, in some example embodiments, a number of zeros are padded in the fields corresponding to the indication information in the beam report.

For example, the terminal device 120 may report 330 the beam report 302 in which a number of zeros are padded in the fields corresponding to the indication information. In other words, if the second indication indicates that no set B satisfying the second type of predefined criteria (i.e., the second indication has a value of “1”), a number of zeros are padded in the following fields of the beam report: list ID, set ID, beam ID of the specific or unique beam.

In some example embodiments, the beam ID in the indication information indicates a specific beam which is comprised in the selected set of beams but is not comprised in any other set of beams amongst the one or more sets of beams.

For example, the terminal device may need to report at least information related to the selected set B (i.e., indication information of the selected set B, e.g., number of beams to report and beam combination) and beam information corresponding to the selected set B (e.g., L1-RSRPs of all beams in the selected set B, beam IDs also may be included). For the indication information of the selected set B, the following can be considered.

In one example, multiple set Bs have the same number of beams. In this case, only beam combination in the selected set B needs to be reported. For example, beam ID of the beams in the selected set B (e.g., CRI/SSBRI) and L1-RSRP of all beams in the selected set B are reported by the terminal device 120 to the network device 110. For another example, when the beams in any two set Bs are fully not overlapping, or the beams in any two set Bs are partially overlapping but there is at least one unique beam in each set B, and the unique beam(s) in a set B refers to the beams does not overlap with any beam in another set B, the beam ID of only one specific beam in the selected set B can be used to indicate the selected set B.

Additionally, in some example embodiments, the specific beam is at least one of: a beam having the lowest or largest reference signal resource ID in the selected set of beams, or a beam having the largest quality matric in the selected set of beams.

In one example, when the indication information is Beam ID of the beams in the selected set B (e.g., CRI/SSBRI), the Beam ID and L1-RSRPs corresponding to beams in the selected set B may be reported by the terminal device 120 to the network device 110. In this case, the number of beams to report and beam combination can be indicated by the beam ID of the specific beam in the selected set B. The beam ID can be a CRI/SSBRI. The specific or predefined beam can be the beam having the lowest (or largest) RS resource ID in the selected set B. Bitwidth for the beam ID (i.e., CRI/SSBRI) can be determined based on a formula: ┌ log 2 K1┐, and the value K1 can be determined based on the number of beams in the set C. For example, K1 can be equal to the number of beams in the set C.

In another example, the terminal device 120 reports the beam ID of one unique beam in the selected set B and the L1-RSRPs corresponding to the selected set B. The unique beam has the largest L1-RSRP in the selected set B.

In some example embodiments, the beam ID in the beam information indicates a beam having the largest quality metric in the selected set of beams.

For example, the terminal device 120 may report the beam ID of one unique beam in the selected set B and the L1-RSRPs corresponding to the selected set B. The unique beam has the largest L1-RSRP in the selected set B.

In some example embodiments, the number of beams in the beam information is determined based on the number of beams in the selected set of beams or a set of beams.

In some example embodiments, a bitwidth for the beam ID in the indication information is determined based on the number of beams in the configured set of beams.

In some example embodiments, a bitwidth for the beam ID in the beam information is determined based on the number of beams in the selected set of beams, the set of beams having the largest number of beams, or the configured set of beams.

In some example embodiments, a bitwidth for the set ID is determined based on the number of set of beams in the list corresponding to the selected set of beams, the number of set of beams in the list having the largest number of sets of beams, or the number of configured sets of beams.

In some example embodiments, a bitwidth for the list ID in the beam information is determined based on the number of lists.

In some example embodiments, the beam report comprises a first part with a fixed bitwidth (also referred to as “payload size”) and a second part with an unfixed bitwidth, the first part comprises at least one of: partial indication information, or none of or partial beam information, the second part comprises at least one of: the rest indication information, or the rest beam information. The partial indication information and the rest indication information do not overlap with each other and together constitute the indication information, the none of or partial beam information and the rest beam information do not overlap with each other and together constitute the beam information.

Additionally, in some example embodiments, if the second part includes the beam ID in the beam information, and a bitwidth for the beam ID is determined based on the number of beams in the set of beams indicated by at least part of the indication information in the first part.

In some example embodiments, the second part comprises the beam ID in the indication information, and a bitwidth for the beam ID is determined based on the number of beams in the list indicated by the list ID in the first part.

In some example embodiments, the second part comprises the set ID, and a bitwidth for the set ID is determined based on the number of set of beams in the list indicated by the list ID in the first part.

In some example embodiments, the second part comprises the beam information, the number of beams in the beam information in the second part is determined based on the number of beams in the set of beams indicated by at least part of the indication information in the first part.

In some example embodiments, the first part comprises the beam information and the second part comprises the beam information. The beam information in the first part comprises M1 quality metric(s) and the second part comprises M2 quality metric(s), the sum of M1 and M2 is equal to M, which is the number of quality metrics in the beam information.

In some example embodiments, the value of the M1 is determined based on the number of beams in the set of beams having the least number of beams.

For example, set ID corresponding to the selected set B (e.g., set ID) and L1-RSRP of all beams in the selected set B may be reported by the terminal device 120 to the network device 110. If the terminal device 120 is provided with set ID explicitly, the set ID corresponding to the selected set B can be used to indicate the selected set B.

In some example embodiments, multiple set Bs have different number of beams. In this case, the terminal device 120 needs to report at least information related to the selected set B (i.e., indication information of the selected set B) and corresponding L1-RSRPs (of all beams in the selected set B).

When multiple set Bs have different number of beams, the overhead of beam reporting (i.e., number of beams to report) is unfixed, so CSI part 1 and CSI part 2 (similar to CSI reporting) can be introduced and used to report the selected set B and corresponding L1-RSRPs. The information in CSI part 1 have fixed payload size. The information in CSI part 2 may have unfixed payload size and is determined based on the (indicated) information in CSI part 1.

The number of beams to report (represented by “N”) can be determined based on (i.e., N is equal to) the number of beams in the selected set B or a set B implicitly. It may imply that the terminal device 120 is not configured (provided) with K (i.e., number of beams to report).

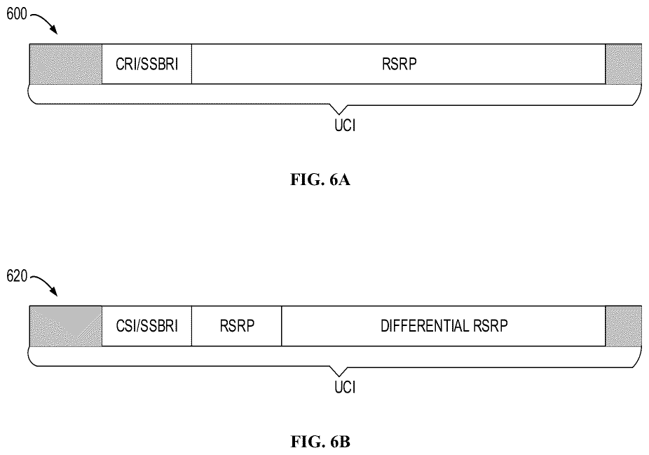

In one example, the L1-RSRPs can be reported by absolute reporting, i.e., the absolute value (called as “RSRP”) of the L1-RSRP is used to report all L1-RSRPs. Bitwidth for the RSRP can be 7 bits. This will be described in detail later with reference to FIG. 6A.

In this case, the number of RSRPs can be N. For example, the mapping order of CSI fields (i.e., CRI/SSBRI and RSRP) of a beam report (i.e., CSI report) can be as illustrated in Table 1.

TABLE 1

| CSI report number | CSI fields |
|---|---|
| CSI report #n | CRI or SSBRI |
| | RSRP #1 |
| | RSRP #2 |
| | . . . |
| | RSRP #N |

In the beam report as illustrated in Table 1, for example, the N RSRPs are arranged in ascending (or descending) order according to the beam ID (e.g., CSI-RS/SSB resource ID, CRI/SSBRI in the selected set B) of the corresponding N beams.

In another example, the L1-RSRPs can be reported by differential reporting, i.e., the absolute value is used to report the largest L1-RSRP, and the difference value (i.e., difference between the largest L1-RSRP and the other L1-RSRP, called as “differential RSRP”) is used to report the other L1-RSRPs. In this case, bitwidth for the RSRP can be 7 bits, and bitwidth for the differential RSRP can be P (0<P<7) bits. This will be described in detail later with reference to FIG. 6B.

In this case, the number of RSRP can be 1, and the number of differential RSRPs (i.e., differential RSRP field) can be N−1. For example, the mapping order of CSI fields (i.e., CRI/SSBRI, RSRP and differential RSRPs) of a beam report can be as illustrated in Table 2.

TABLE 2

| CSI report number | CSI fields |
|---|---|
| CSI report #n | CRI or SSBRI |
| | RSRP |
| | Differential RSRP #1 |
| | Differential RSRP #2 |
| | . . . |
| | Differential RSRP #N-1 |

In the beam report as illustrated in Table 2, for example, the N−1 differential RSRPs are arranged in ascending (or descending) order according to the beam ID of the corresponding N−1 beams.

FIG. 6A illustrates a schematic chart 600 illustrating configuration of UCI in accordance with some embodiments of the present disclosure. Only for the purpose of discussion, the schematic chart 600 will be described with reference to FIGS. 2 and 5A-5C.

In the example illustrated in FIG. 6A, the UCI reported by absolute reporting comprises an ID (for example, a beam ID indicated by CRI/SSBRI) and the absolute value of the RSRPs. Bitwidth for the RSRP can be 7 bits. The start portion and ending portion in gray denotes other information or reserved bits in the UCI.

FIG. 6B illustrates a schematic chart 620 illustrating configuration of UCI in accordance with some embodiments of the present disclosure. Only for the purpose of discussion, the schematic chart 620 will be described with reference to FIGS. 2, 5A-5C and 6A.

In the example illustrated in FIG. 6B, the L1-RSRPs can be reported by differential reporting, i.e., the absolute value is used to report the largest L1-RSRP, and the difference value (i.e., difference between the largest L1-RSRP and the other L1-RSRP, called as “differential RSRP”) is used to report the other L1-RSRPs.

In this case, the UCI may comprise an ID (for example, a beam ID indicated by CRI/SSBRI), the absolute value of the largest RSRP, and differential RSRPs. Bitwidth for the RSRP can be 7 bits. Bitwidth for the differential RSRP can be P (0<P<7) bits. The start portion and ending portion in gray denotes other information or reserved bits in the UCI.

In one example, the terminal device 120 reports the beam ID of one unique beam in the selected set B and the L1-RSRPs corresponding to the selected set B. The reported one unique beam can be a specific or predefined beam in the unique beam(s) corresponding to the selected set B, and the specific or predefined beam can be the beam having the lowest (or largest) RS resource ID in the unique beam(s).

In this case, the determination of the beam ID of the one unique beam is based on ┌ log₂ K1┐, where the value of K1 can be determined based on the number of beams in the set C. The L1-RSRPs can be reported by absolute reporting, i.e., NRSRPs. For example, the mapping order of CSI fields (i.e., CRI/SSBRI and RSRP) of a beam report can be the same as illustrated in Table 1.

In another example, the terminal device 120 reports the beam ID of one unique beam in the selected set B and the L1-RSRPs corresponding to the selected set B. The unique beam has the largest L1-RSRP in the selected set B.

In this case, the determination of the beam ID of the one unique beam is based on ┌ log₂ K1┐, where the value of K1 can be determined based on the number of beams in the set C. The bitwidth beam ID of the beam having the largest L1-RSRP can be determined based on: ┌ log₂ K2┐, where the value of K2 can be determined based on the number of beams in the selected set B or in a set B (due to the same number of beams for each set B possibly). The L1-RSRPs can be reported by differential reporting, i.e., 1 RSRP and N−1 differential RSRPs. For example, the mapping order of CSI fields (i.e., CRI/SSBRI, CRI/SSBRI, RSRP and differential RSRP) of a beam report can be as illustrated in Table 3.

TABLE 3

| CSI report number | CSI fields |
|---|---|
| CSI report #n | CRI or SSBRI |
| | CRI or SSBRI |
| | RSRP |
| | Differential RSRP #1 |
| | Differential RSRP #2 |
| | . . . |
| | Differential RSRP #N-1 |

In the example illustrated in Table 3, the first CRI/SSBRI refers to the beam ID of the one unique beam, and the second CRI/SSBRI refers to the beam ID of the beam having the largest L1-RSRP.

When the indication information is set ID corresponding to the selected set B (e.g., set ID), the set ID and L1-RSRP corresponding to beams in the selected set B may be reported by the terminal device 120 to the network device 110. In this case, the number of beams to report and beam combination can be indicated by the set ID corresponding to the selected set B.

In one example, the terminal device 120 reports the set ID corresponding to the selected set B and the L1-RSRPs corresponding to the selected set B.

In this case, the bitwidth for the set ID can be determined based on a formula: ┌ log₂ K3┐, where the value of K3 can be determined based on (e.g., K3 is equal to) the number of configured set Bs, or configured AI/ML models or AI/ML model IDs (in the configuration information or associated with the beam report). The L1-RSRPs can be reported by absolute reporting, i.e., N RSRPs. For example, the mapping order of CSI fields (i.e., set ID and RSRP) of a beam report can be as illustrated in Table 4.

TABLE 4

| CSI report number | CSI fields |
|---|---|
| CSI report #n | Set ID |
| | RSRP #1 |
| | RSRP #2 |
| | . . . |
| | RSRP #N |

In another example, the terminal device 120 reports the set ID corresponding to the selected set B, the beam ID of the beam having the largest L1-RSRP and the L1-RSRPs corresponding to the selected set B.

In this case, the bitwidth for the set ID can be determined based on a formula: ┌ log₂ K3┐, where the value of K3 can be determined based on (e.g., K3 is equal to) the number of configured set Bs, or configured AI/ML models or AI/ML model IDs (in the configuration information or associated with the beam report). Determination of the bitwidth for the beam ID of the beam having the largest L1-RSRP is based on: Dog, K21, and K2 is based on the number of beams in the selected set B or in one set B because the number of beams in several set Bs may be the same. The L1-RSRPs can be reported by differential reporting, i.e., 1 RSRP and N−1 differential RSRPs. For example, the mapping order of CSI fields (i.e., set ID, CRI/SSBRI, RSRP and differential RSRP) of a beam report can be as illustrated in Table 5.

TABLE 5

| CSI report number | CSI fields |
|---|---|
| CSI report #n | Set ID |
| | CRI or SSBRI |
| | RSRP |
| | Differential RSRP #1 |
| | Differential RSRP #2 |
| | . . . |
| | Differential RSRP #N-1 |

In one example, CSI part 1 comprises the beam ID of the specific beam in the selected set B, and CSI part 2 comprises the L1-RSRPs corresponding to the selected set B.

In this case, the number of L1-RSRPs to be reported in CSI part 2 can be determined based on the number of beams in the selected set B determined by the indicated beam in CSI part 1. It also means that the bitwidth for CSI part 2 is determined based on the information indicated by CSI part 1. The mapping order of CSI fields (i.e., CRI/SSBRI and RSRP) of a beam report can be as illustrated in Table 6.

TABLE 6

| CSI report number | CSI fields |
|---|---|
| CSI report #n | CRI or SSBRI |
| CSI part 1 | |
| CSI report #n | RSRP #1 |
| CSI part 2 | RSRP #2 |
| | . . . |
| | RSRP #M |

In another example, CSI part 1 comprises the beam ID of the beam having the largest L1-RSRP in the selected set B. CSI part 2 comprises the L1-RSRPs corresponding to the selected set B.

In this case, the number of L1-RSRPs to be reported in CSI part 2 can also be determined based on the number of beams in the selected set B determined by the indicated beam in CSI part 1. It also means that the bitwidth for CSI part 2 is determined based on the information indicated by CSI part 1. The mapping order of CSI fields (i.e., CRI/SSBRI, RSRP and differential RSRP) of a beam report can be as illustrated in Table 7.

TABLE 7

| CSI report number | CSI fields |
|---|---|
| CSI report #n | CRI or SSBRI |
| CSI part 1 | |
| CSI report #n | RSRP |
| CSI part 2 | Differential RSRP #1 |
| | Differential RSRP #2 |
| | . . . |
| | Differential RSRP #M-1 |

In another example, CSI part 1 comprises the beam ID of the specific beam or the beam having the largest L1-RSRP in the selected set B and M1 L1-RSRPs corresponding to the selected set B. CSI part 2 comprises M2 L1-RSRPs corresponding to the selected set B.

In this case, the (total) number of beams (i.e., L1-RSRPs) to be reported is determined based on the number of beams (represented by “M”) in the selected set B. M1 can be fixed (e.g., equal to 1) or configured by the network device 110. Additionally or alternatively, M1 can be determined based on the number of beams in the set B having the least number of beams. M2 (i.e., the number of L1-RSRPs to be reported in CSI part 2) can be determined based on the number of beams in the (selected) set B corresponding to the indicated beam in CSI part 1 and M1, i.e., M2=M−M1. It also means that the bitwidth for CSI part 2 is determined based on the information indicated by CSI part 1. Specifically, if M=M1, there will be no L1-RSRP to be reported in CSI part 2. If M>M1, there will be M−M1 to be reported in CSI part 2. The mapping order of CSI fields (e.g., CRI/SSBRI, RSRP, differential RSRP) of a beam report can be as illustrated in Table 8 and Table 9.

TABLE 8

| CSI report number | CSI fields |
|---|---|
| CSI report #n | CRI or SSBRI |
| CSI part 1 | RSRP #1 |
| | . . . |
| | RSRP #M1-1 |
| CSI report #n | RSRP #M1 |
| CSI part 2 | . . . |
| | RSRP #M-1 |

TABLE 9

| CSI report number | CSI fields |
|---|---|
| CSI report #n | CRI or SSBRI |
| CSI part 1 | RSRP #1 |
| | . . . |
| | Differential RSRP #M1-1 |
| CSI report #n | Differential RSRP #M1 |
| CSI part 2 | . . . |
| | Differential RSRP #M-1 |

It is to be noted that, as to the determination of the bitwidth for the beam ID (i.e., CRI/SSBRI) of the specific beam or the beam having the largest RSRP, it can also be based on ┌ log₂ K1┐, where K1 can be determined based on the number of beams in set C, as mentioned above.

It is also to be noted that, as to the method for reporting the L1-RSRPs, it is similar to the method described above, i.e., by absolute reporting or by differential reporting.

In one example, CSI part 1 comprises the beam ID of the unique beam in the selected set B, and CSI part 2 comprises the L1-RSRPs corresponding to the selected set B. In this case, the mapping order of CSI fields (i.e., CRI/SSBRI and RSRP) of a beam report can be as illustrated in Table 10.

TABLE 10

| CSI report number | CSI fields |
|---|---|
| CSI report #n | CRI or SSBRI |
| CSI part 1 | |
| CSI report #n | RSRP #1 |
| CSI part 2 | RSRP #2 |
| | . . . |
| | RSRP #M |

In another example, CSI part 1 comprises the beam ID of the unique beam in the selected set B and the beam ID of the beam having the largest L1-RSRP in the selected set B. CSI part 2 comprises the L1-RSRPs corresponding to the selected set B.

In this case, the bitwidth for the beam ID of the beam having the largest L1-RSRP can be determined based on: ┌ log₂ K4┐, where the value of K4 can be determined based on the number of beams in the set B having the maximum number of beams, or the number of beams in the set C (i.e., K1). The mapping order of CSI fields (i.e., CRI/SSBRI, CRI/SSBRI, RSRP and differential RSRP) of a beam report can be as illustrated in Table 11.

TABLE 11

| CSI report number | CSI fields |
|---|---|
| CSI report #n | CRI or SSBRI |
| CSI part 1 | CRI or SSBRI |
| CSI report #n | RSRP |
| CSI part 2 | Differential RSRP #1 |
| | Differential RSRP #2 |
| | . . . |
| | Differential RSRP #M-1 |

In another example, CSI part 1 comprises the beam ID of the unique beam in the selected set B. CSI part 2 comprises the beam ID of the beam having the largest L1-RSRP in the selected set B and the L1-RSRPs corresponding to the selected set B.

In this case, the bitwidth for the beam ID of the beam having the largest L1-RSRP can be determined based on: ┌ log₂ K5┐, where the value of K5 can be determined based on the number of beams in the indicated selected set B in CSI part 1 (i.e., the selected set B). The mapping order of CSI fields (i.e., CRI/SSBRI, CRI/SSBRI, RSRP and differential RSRP) of a beam report can be as illustrated in Table 12.

TABLE 12

| CSI report number | CSI fields |
|---|---|
| CSI report #n | CRI or SSBRI |
| CSI part 1 | |
| CSI report #n | CRI or SSBRI |
| CSI part 2 | RSRP |
| | Differential RSRP #1 |
| | Differential RSRP #2 |
| | . . . |
| | Differential RSRP #M-1 |

In another example, CSI part 1 comprises the beam ID of the unique beam in the selected set B and M1 L1-RSRPs corresponding to the selected set B. CSI part 2 comprises M2 (=M−M1) L1-RSRPs corresponding to the selected set B.

In this case, the mapping order of CSI fields (i.e., CRI/SSBRI and RSRP) of a beam report can be as illustrated in Table 13.

TABLE 13

| CSI report number | CSI fields |
|---|---|
| CSI report #n | CRI or SSBRI |
| CSI part 1 | RSRP #1 |
| | . . . |
| | RSRP #M1-1 |
| CSI report #n | RSRP #M1 |
| CSI part 2 | . . . |
| | RSRP #M-1 |

In another example, CSI part 1 comprises the beam ID of the unique beam in the selected set B, the beam ID of the beam having the largest L1-RSRP in the selected set B and M1 L1-RSRPs corresponding to the selected set B. CSI part 2 comprises M2 (=M−M1) L1-RSRPs corresponding to the selected set B.

In this case, the bitwidth for the beam ID of the beam having the largest L1-RSRP can be determined based on: ┌ log₂ K4┐, where the value of K4 can be determined based on the number of beams in the set B having the maximum number of beams, or the number of beams in the set C (i.e., K1). The mapping order of CSI fields (i.e., CRI/SSBRI, CRI/SSBRI, RSRP and differential RSRP) of a beam report can be as illustrated in Table 14.

TABLE 14

| CSI report number | CSI fields |
|---|---|
| CSI report #n | CRI or SSBRI |
| CSI part 1 | CRI or SSBRI |
| | RSRP #1 |
| | . . . |
| | Differential RSRP #M1-1 |
| CSI report #n | Differential RSRP #M1 |
| CSI part 2 | . . . |
| | Differential RSRP #M-1 |

In another example, the beam having the largest L1-RSRP in the selected set B may be consistent with the one unique beam. Therefore, CSI part 1 comprises the beam ID of the one unique beam and a new indication (hereafter also referred to as “first indication”). CSI part 2 comprises the beam ID of the beam having the largest L1-RSRP in the selected set B (if reported) and the L1-RSRPs corresponding to the set B. The first indication indicates whether the beam having the largest L1-RSRP in the selected set B is consistent with the one unique beam (indicated in CSI part 1), with two states/values of the first indication, e.g., 0 or 1. For example, if the first indication indicates “1” (i.e., consistent), the beam ID of the beam having the largest L1-RSRP does not need to be reported.

In this case, the mapping order of CSI fields (i.e., CRI/SSBRI, first indication, CRI/SSBRI, RSRP and differential RSRP) of a beam report can be as illustrated in Table 15.

TABLE 15

| CSI report number | CSI fields |
|---|---|
| CSI report #n | CRI or SSBRI |
| CSI part 1 | First indication |
| CSI report #n | CRI or SSBRI |
| CSI part 2 | RSRP |
| | Differential RSRP #1 |
| | Differential RSRP #2 |
| | . . . |
| | Differential RSRP #M-1 |

It is to be noted that, as to the determination of the bitwidth for the beam ID (i.e., CRI/SSBRI) of the specific beam or the beam having the largest RSRP, it can also be based on log, fil, where K1 can be determined based on the number of beams in set C, as mentioned above.

It is also to be noted that, as to the definition and determination of M1, the above description may be referred to. M2 (i.e., the number of L1-RSRPs to be reported in CSI part 2) can be determined based on the number of beams in the selected set B determined by the indicated unique beam in CSI part 1 and M1. It also means that the bitwidth for CSI part 2 is determined based on the information indicated by CSI part 1.

In one example, CSI part 1 comprises the set ID corresponding to the selected set B. CSI part 2 comprises the L1-RSRPs corresponding to the selected set B.

In this case, the mapping order of CSI fields (i.e., set ID or model ID and RSRP) of a beam report can be as illustrated in Table 16.

TABLE 16

| CSI report number | CSI fields |
|---|---|
| CSI report #n | Set ID |
| CSI part 1 | |
| CSI report #n | RSRP #1 |
| CSI part 2 | RSRP #2 |
| | . . . |
| | RSRP #M |

In another example, CSI part 1 comprises the set ID corresponding to the selected set B and the beam ID of the beam having the largest L1-RSRP in the selected set B. CSI part 2 comprises the L1-RSRPs corresponding to the selected set B.

In this case, the mapping order of CSI fields (i.e., set ID or model ID, CRI/SSBRI, RSRP and differential RSRP) of a beam report can be as illustrated in Table 17.

TABLE 17

| CSI report number | CSI fields |
|---|---|
| CSI report #n | Set ID or Model ID |
| CSI part 1 | CRI or SSBRI |
| CSI report #n | RSRP |
| CSI part 2 | Differential RSRP #1 |
| | Differential RSRP #2 |
| | . . . |
| | Differential RSRP #M-1 |

In another example, CSI part 1 comprises the set ID corresponding to the selected set B. CSI part 2 comprises the beam ID of the beam having the largest L1-RSRP in the selected set B and the L1-RSRPs corresponding to the selected set B.

In this case, the mapping order of CSI fields (i.e., set ID or model ID, CRI/SSBRI, RSRP and differential RSRP) of a beam report can be as illustrated in Table 18.

TABLE 18

| CSI report number | CSI fields |
|---|---|
| CSI report #n | Set ID or Model ID |
| CSI part 1 | |
| CSI report #n | CRI or SSBRI |
| CSI part 2 | RSRP |
| | Differential RSRP #1 |
| | Differential RSRP #2 |
| | . . . |
| | Differential RSRP #M-1 |

In another example, CSI part 1 comprises the set ID corresponding to the selected set B and M1 L1-RSRPs corresponding to the selected set B. CSI part 2 comprises M2 L1-RSRPs corresponding to the selected set B. In this case, the mapping order of CSI fields (i.e., set ID or model ID and RSRP) of a beam report can be as illustrated in Table 19.

TABLE 19

| CSI report number | CSI fields |
|---|---|
| CSI report #n | Set ID or Model ID |
| CSI part 1 | RSRP #1 |
| | . . . |
| | RSRP #M1-1 |
| CSI report #n | RSRP #M1 |
| CSI part 2 | . . . |
| | RSRP #M-1 |

In another example, CSI part 1 comprises the set ID corresponding to the selected set B, the beam ID of the beam having the largest L1-RSRP in the selected set B and M1 L1-RSRPs corresponding to the selected set B. CSI part 2 comprises M2 L1-RSRPs corresponding to the selected set B.

In this case, the mapping order of CSI fields (i.e., set ID or model ID, CRI/SSBRI, RSRP and differential RSRP) of a beam report can be as illustrated in Table 20.

TABLE 20

| CSI report number | CSI fields |
|---|---|
| CSI report #n | Set ID or Model ID |
| CSI part 1 | CRI or SSBRI |
| | RSRP #1 |
| | . . . |
| | Differential RSRP #M1-1 |
| CSI report #n | Differential RSRP #M1 |
| CSI part 2 | . . . |
| | Differential RSRP #M-1 |

It is to be noted that, as to the determination of the bitwidth for the set ID, it can also be based on ┌ log₂ K3┐, where K3 can be determined based on the number of set Bs, or configured AI/ML models or AI/ML model IDs, as mentioned above.

It is also to be noted that, as to the definition and determination of M1 (i.e., the number of L1-RSRPs to be reported in CSI part 1), the above description may be referred to. M2 (i.e., the number of L1-RSRPs to be reported in CSI part 2) can be determined based on the number of beams in the selected set B corresponding to the indicated set ID in CSI part 1 and M1. It also means that the bitwidth for CSI part 2 is determined based on the information indicated by CSI part 1.

When the indication information is list ID, set ID corresponding to the selected set B (e.g., list ID+set ID), the list ID, set ID and L1-RSRP corresponding to beams in the selected set B may be reported by the terminal device 120 to the network device 110. In this case, the number of beams to report can be indicated by the list ID and set ID corresponding to the selected set B, and the beam combination can be indicated by the set ID.

In one example, CSI part 1 comprises the list ID corresponding to the selected set B. CSI part 2 comprises the set ID corresponding to the selected set B and the L1-RSRPs corresponding to the selected set B.

In this case, the bitwidth for the set ID can be determined based on: ┌ log₂ K7┐, where the value of K7 can be determined based on the number of set Bs in the indicated list in CSI part 1. The number of L1-RSRPs to be reported in CSI part 2 can be determined based on the number of beams corresponding to the indicated list in CSI part 1. The mapping order of CSI fields (i.e., list ID, set ID and RSRP) of a beam report can be as illustrated in Table 21.

TABLE 21

| CSI report number | CSI fields |
|---|---|
| CSI report #n | List ID |
| CSI part 1 | |
| CSI report #n | Set ID |
| CSI part 2 | RSRP #1 |
| | RSRP #2 |
| | . . . |
| | RSRP #M |

In another example, CSI part 1 comprises the list ID. CSI part 2 comprises the set ID, the beam ID of the beam having the largest L1-RSRP and the L1-RSRPs corresponding to the selected set B.

In this case, the bitwidth for the set ID can be determined based on: ┌ log₂ K₇┐, where the value of K7 can be determined based on the number of set Bs in the indicated list in CSI the part 1. The bitwidth for the beam ID can be determined based on: ┌ log₂ K9┐ where value of K9 can be determined based on the number of beams corresponding to the indicated list in CSI part 1. The number of L1-RSRPs to be reported in CSI part 2 can be determined based on the number of beams corresponding to the indicated list in CSI part 1. The mapping order of CSI fields (i.e., list ID, set ID, CRI/SSBRI, RSRP and differential RSRP) of a beam report can be as illustrated in Table 22.

TABLE 22

| CSI report number | CSI fields |
|---|---|
| CSI report #n | List ID |
| CSI part 1 | |
| CSI report #n | Set ID |
| CSI part 2 | CRI or SSBRI |
| | RSRP #1 |
| | Differential RSRP #1 |
| | Differential RSRP #2 |
| | . . . |
| | Differential RSRP #M-1 |

In another example, CSI part 1 comprises the list ID and the set ID. CSI part 2 comprises the L1-RSRPs corresponding to the selected set B.

In this case, the bitwidth for the set ID can be determined based on: [log, K8], where the value of K8 can be determined based on the number of set Bs in a list (due to the same number of set Bs for each list possibly), or the number of set Bs in the list having the maximum number of set Bs. The number of L1-RSRPs to be reported in CSI part 2 can be determined based on the number of beams in the indicated set Bs in the indicated list in CSI part 1. The mapping order of CSI fields (i.e., list ID, set ID and RSRP) of a beam report can be as illustrated in Table 23.

TABLE 23

| CSI report number | CSI fields |
|---|---|
| CSI report #n | List ID |
| CSI part 1 | Set ID |
| CSI report #n | RSRP #1 |
| CSI part 2 | RSRP #2 |
| | . . . |
| | RSRP #M |

In another example, CSI part 1 comprises the list ID, the set ID and the beam ID of the beam having the largest L1-RSRP. CSI part 2 comprises the L1-RSRPs corresponding to the selected set B.

In this case, the bitwidth for the set ID can be determined based on: ┌ log₂ K8┐, where the value of K8 can be determined based on the number of set Bs in a list (due to the same number of set Bs for each list possibly), or the number of set Bs in the list having the maximum number of set Bs. As to the determination of the bitwidth for the beam ID, it is similar to the way described above, i.e., it is determined based on ┌ log₂ K4┐, where the value of K4 is determined based on the number of beams in the set B having the maximum number of beams, or the number of beams in the set C. The number of L1-RSRPs to be reported in CSI part 2 can be determined based on the number of beams in the indicated set Bs in the indicated list in CSI part 1. The mapping order of CSI fields (i.e., list ID, set ID, CRI/SSBRI, RSRP and differential RSRP) of a beam report can be as illustrated in Table 24.

TABLE 24

| CSI report number | CSI fields |
|---|---|
| CSI report #n | List ID |
| CSI part 1 | Set ID |
| | CRI or SSBRI |
| CSI report #n | RSRP #1 |
| CSI part 2 | Differential RSRP #1 |
| | Differential RSRP #2 |
| | . . . |
| | Differential RSRP #M-1 |

In another example, CSI part 1 comprises the list ID and the set ID. CSI part 2 comprises the beam ID of the beam having the largest L1-RSRP and the L1-RSRPs corresponding to the selected set B.

In this case, the bitwidth for the set ID can be determined based on: ┌ log₂ K₈┐, where the value of K8 can be determined based on the number of set Bs in a list (due to the same number of set Bs for each list possibly), or the number of set Bs in the list having the maximum number of set Bs. The bitwidth for the beam ID can be determined based on: ┌ log₂ K10┐, where the value of K10 can be determined based on the number of beams in the indicated set B in the indicated list in CSI part 1. The number of L1-RSRPs to be reported in CSI part 2 can be determined based on the number of beams in the indicated set Bs in the indicated list in CSI part 1. The mapping order of CSI fields (i.e., list ID, set ID, CRI/SSBRI, RSRP and differential RSRP) of a beam report can be as illustrated in Table 25.

TABLE 25

| CSI report number | CSI fields |
|---|---|
| CSI report #n | List ID |
| CSI part 1 | Set ID |
| CSI report #n | CRI or SSBRI |
| CSI part 2 | RSRP #1 |
| | Differential RSRP #1 |
| | Differential RSRP #2 |
| | . . . |
| | Differential RSRP #M-1 |

In another example, CSI part 1 comprises the list ID, the set ID and M1 L1-RSRPs corresponding to the selected set B. CSI part 2 comprises M2 L1-RSRPs corresponding to the selected set B.

In this case, the bitwidth for the set ID can be determined based on: ┌ log₂ K8┐, where the value of K8 can be determined based on the number of set Bs in a list (due to the same number of set Bs for each list possibly), or the number of set Bs in the list having the maximum number of set Bs. Determination and details of M1 are similar to the way described above. The value of M2 (i.e., the number of L1-RSRPs to be reported in CSI part 2) can be determined based on the number of beams in the indicated set Bs in the indicated list in CSI part 1 and the value of M1 (i.e., the number of L1-RSRPs to be reported in CSI part 1). The mapping order of CSI fields (i.e., list ID, set ID and RSRP) of a beam report can be as illustrated in Table 26.

TABLE 26

| CSI report number | CSI fields |
|---|---|
| CSI report #n | List ID |
| CSI part 1 | Set ID |
| | RSRP #1 |
| | . . . |
| | RSRP #M1-1 |
| CSI report #n | RSRP #M1 |
| CSI part 2 | . . . |
| | RSRP #M-1 |

In another example, CSI part 1 comprises the list ID, the set ID, the beam ID of the beam having the largest L1-RSRP and M1 L1-RSRPs corresponding to the selected set B. CSI part 2 comprises M2 L1-RSRPs corresponding to the selected set B.

In this case, the bitwidth for the set ID can be determined based on: ┌ log₂ K8┐, where the value of K8 can be determined based on the number of set Bs in a list (due to the same number of set Bs for each list possibly), or the number of set Bs in the list having the maximum number of set Bs. As to the determination of the bitwidth for the beam ID, it is similar to the way described above, i.e., it is determined based on ┌ log₂ K4┐, where the value of K4 is determined based on the number of beams in the set B having the maximum number of beams, or the number of beams in the set C. Determination and details of M1 are similar to the way described above. M2 (i.e., the number of L1-RSRPs to be reported in CSI part 2) can be determined based on the number of beams in the indicated set Bs in the indicated list in CSI part 1 and M1. The mapping order of CSI fields (i.e., list ID, set ID, CRI/SSBRI, RSRP and differential RSRP) of a beam report can be as illustrated in Table 27.

TABLE 27

| CSI report number | CSI fields |
|---|---|
| CSI report #n | List ID |
| CSI part 1 | Set ID |
| | CRI or SSBRI |
| | RSRP #1 |
| | . . . |
| | Differential RSRP #M1-1 |
| CSI report #n | Differential RSRP #M1 |
| CSI part 2 | . . . |
| | Differential RSRP #M-1 |

It is to be noted that, bitwidth for the list ID can be determined based on: ┌ log₂ K6┐, where the value of K6 can be determined based on (e.g., K6 is equal to) the number of configured lists of set Bs, configured AI/ML models or AI/ML model IDs, or AI/ML model groups or AI/ML model group IDs (in the configuration information or associated with the beam report).

It is also to be noted that, as to the definition and determination of M1, the above description may be referred to. M2 (i.e., the number of L1-RSRPs to be reported in CSI part 2) can be determined based on the number of beams in the selected set B corresponding to the indicated set ID in CSI part 1 and M1. It also means that the bitwidth for CSI part 2 is determined based on the information indicated by CSI part 1.

In some example embodiments, if no set B satisfy the second type of criteria, UE can report the L1-RSRPs corresponding to the set C.

For example, in this case, a new indication field (called as “second indication”) can be introduced in CSI part 1, as mentioned above. The second indication is used to indicate whether there is at least one set B satisfying the second type of predefined criteria. For example, 1 bit (i.e., “1” and “0”) indicates whether there is at least one set B satisfying the second type of predefined criteria or not. If the second indication indicates that there is no set B satisfying the second type of predefined criteria, the terminal device 120 ignores (or omits) the other fields (e.g., list ID, set ID, beam ID of the specific or unique beam) in CSI part 1. Meanwhile, a number of zeros are padded in these fields that the terminal device 120 ignores. For example, the mapping order of CSI fields (i.e., second indication, list ID, set ID and RSRP) of a beam report may be as illustrated in Table 28.

TABLE 28

| CSI report number | CSI fields |
|---|---|
| CSI report #n | Second indication |
| CSI part 1 | List ID |
| CSI report #n | Set ID |
| CSI part 2 | RSRP #1 |
| | RSRP #2 |
| | . . . |
| | RSRP #M |

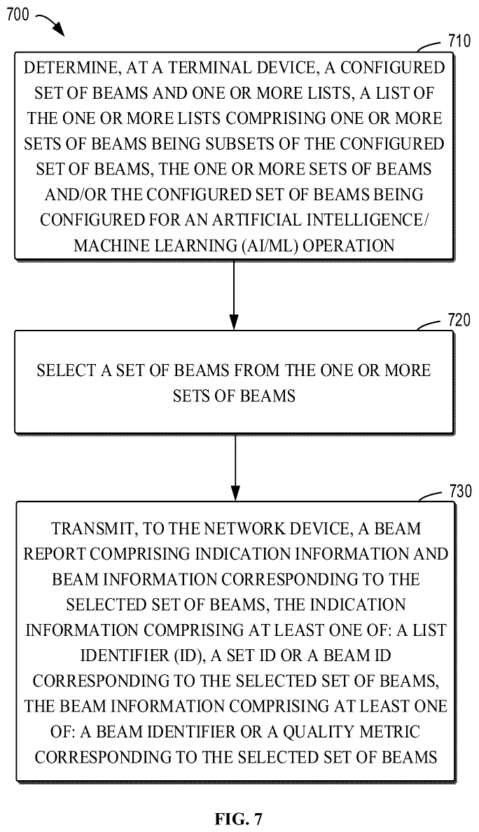

FIG. 7 illustrates a flowchart of an example method 700 implemented at a terminal device in accordance with some embodiments of the present disclosure. For the purpose of discussion, the method 700 will be described from the perspective of the terminal device 120 with reference to FIG. 1.

At block 710, the terminal device 120 determines a configured set of beams and one or more lists. Each list of the one or more lists comprises one or more sets of beams. Each set of beams is a subset of the configured set of beams. The one or more sets of beams and/or the configured set of beams is configured at the terminal device 120 for an AI/ML operation. At block 720, the terminal device 120 selects a set of beams from the one or more sets of beams. At block 730, the terminal device 120 transmits to the network device 110 a beam report comprising indication information and beam information corresponding to the selected set of beams. The indication information comprises at least one of: a list ID, a set ID or a beam ID corresponding to the selected set of beams, and the beam information comprises at least one of: a beam ID or a quality metric corresponding to the selected set of beams.

In some example embodiments, the terminal device 120 receives, from the network device 110, a set C and one or more lists. Each list of the one or more lists comprises one or more set B. Each set B is a subset of the set C. The one or more set B and/or the set C is configured at the terminal device 120 for an AI/ML operation. The terminal device 120 selects a set B from the one or more set Bs. Then, the terminal device 120 transmits to the network device 110 a beam report comprising indication information and beam information corresponding to the selected set B. The indication information comprises at least one of: a list ID, a set ID or a beam ID corresponding to the selected set B, and the beam information comprises at least one of: a beam ID or a quality metric corresponding to the selected set B.

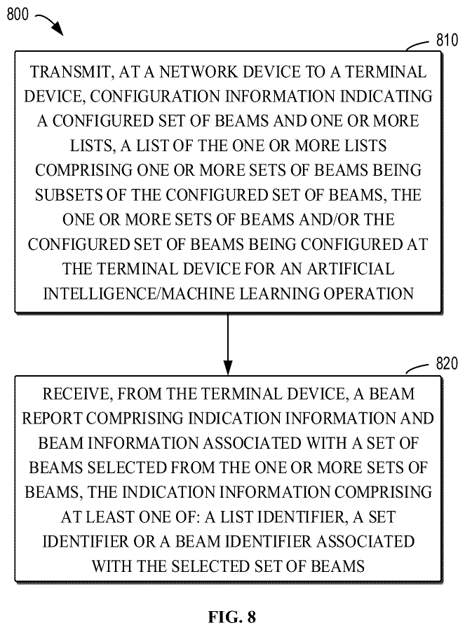

FIG. 8 illustrates a flowchart of an example method 800 implemented at a network device in accordance with some embodiments of the present disclosure. For the purpose of discussion, the method 800 will be described from the perspective of the network device 110 with reference to FIG. 1.

At block 810, the network device 110 transmits to the terminal device 120 configuration information indicating a configured set of beams and one or more lists. Each list of the one or more lists comprises one or more sets of beams, each set of beams is a subset of the configured set of beams, the one or more sets of beams and/or the configured set of beams is configured at the terminal device 120 for an AI/ML operation. At block 820, the network device 110 receives from the terminal device 120 a beam report comprising indication information and beam information associated with a set of beams selected from the one or more sets of beams. The indication information comprises at least one of: a list ID, a set ID or a beam ID associated with the selected set of beams.

In some example embodiments, the network device 110 transmits, to the terminal device 120, configuration information indicating a set C and one or more lists. Each list of the one or more lists comprises one or more set B. Each set B is a subset of the set C. The one or more set Bs and/or the set C is configured at the terminal device 120 for an AI/ML model operation. The network device 110 receives from the terminal device 120 a beam report comprising indication information and beam information associated with a set B selected from the one or more set Bs. The indication information comprises at least one of: a list ID, a set ID or a beam ID associated with the selected set B.

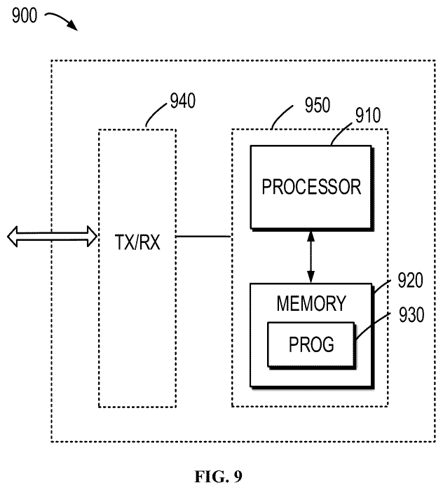

FIG. 9 illustrates a simplified block diagram of a device 900 that is suitable for implementing embodiments of the present disclosure. The device 900 can be considered as a further example implementation of the terminal device 120 and/or the network device 110 as shown in FIG. 1. Accordingly, the device 900 can be implemented at or as at least a part of the terminal device 120 or the network device 110.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 9130. The TX/RX 940 is for bidirectional communications. The TX/RX 940 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 2-8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In summary, embodiments of the present disclosure may provide the following solutions.

The present disclosure provides a method for communication, comprises: determining, at a terminal device, a configured set of beams and one or more lists, a list of the one or more lists comprising one or more sets of beams being subsets of the configured set of beams, the one or more sets of beams and/or the configured set of beams being configured for an Artificial Intelligence/Machine Learning (AI/ML) operation; selecting a set of beams from the one or more sets of beams; and transmitting, to the network device, a beam report comprising indication information and beam information corresponding to the selected set of beams, the indication information comprising at least one of: a list ID, a set ID or a beam ID corresponding to the selected set of beams, the beam information comprising at least one of: a beam ID or a quality metric corresponding to the selected set of beams.

In one embodiment, the selecting the selected set of beams comprises: determining one or more sets of quality metrics corresponding to the one or more sets of beams; and selecting the selected set of beams based on the one or more sets of quality metrics and at least one criterion.

In one embodiment, the method as above, the at least one criterion comprises at least one of the following first type of criteria: a maximum of a set of quality metrics corresponding to the selected set of beams is maximum amongst the one or more sets of beams; a minimum of the set of quality metrics corresponding to the selected set of beams is minimum amongst the one or more sets of beams; a mean or a root mean square of the set of quality metrics corresponding to the selected set of beams is maximum or minimum amongst the one or more sets of beams; a variance or a standard deviation of the set of quality metrics corresponding to the selected set of beams is minimum or maximum amongst the one or more sets of beams; an error between the set of quality metrics and a set of reference quality metrics corresponding to the selected set of beams is minimum amongst the one or more sets of beams; the set ID or the list ID corresponding to the selected set of beams is minimum or maximum amongst the one or more sets of beams; or the number of beams in the selected set of beams is minimum or maximum amongst the one or more sets of beams.

In one embodiment, the method as above, the at least one criterion comprises at least one of the following second type of criteria: a maximum of a set of quality metrics corresponding to the selected set of beams is greater than or equal to a first threshold; a minimum of the set of quality metrics corresponding to the selected set of beams is less than or equal to a second threshold; a mean or a root mean square of the set of quality metrics corresponding to the selected set of beams is greater than or equal to a third threshold, or less than or equal to a fourth threshold; a variance or a standard deviation of the set of quality metrics corresponding to the selected set of beams is less than or equal to a fifth threshold, or greater than or equal to a sixth threshold; or an error between the set of quality metrics and a set of reference quality metrics corresponding to the selected set of beams is less than or equal to a seventh threshold.

In one embodiment, the method as above, the selecting the selected set of beams comprises: determining, based on the one or more sets of quality metrics and the second type of criteria whether a set of beams among the one or more sets of beams is to be selected as the selected set of beams sequentially in a predefined order.

In one embodiment, the method as above, the predefined order is at least one of: an ascending order or a descending order of set ID corresponding to the one or more sets of beams; an ascending order or a descending order of list ID corresponding to the one or more sets of beams; or an ascending order or a descending order of the number of beams in the one or more sets of beams.

In one embodiment, the method further comprises: in response to determining that none of the one or more sets of beams satisfies at least one of the second type of criteria, including beam information corresponding to the configured set of beams in the beam report.

In one embodiment, the method as above, the beam report further comprises an indication indicating whether none of the one or more sets of beams satisfies the second type of criteria.

In one embodiment, the method as above, a number of zeros are padded in the fields corresponding to the indication information in the beam report.

In one embodiment, the method as above, the beam ID in the indication information indicates a specific beam which is comprised in the selected set of beams but is not comprised in any other set of beams amongst the one or more sets of beams.

In one embodiment, the method as above, the specific beam is at least one of: a beam having the lowest or largest reference signal resource ID in the selected set of beams, or a beam having the largest quality matric in the selected set of beams.

In one embodiment, the method as above, the beam ID in the beam information indicates a beam having the largest quality metric in the selected set of beams.

In one embodiment, the method as above, the number of beams in the beam information is determined based on the number of beams in the selected set of beams or a set of beams.

In one embodiment, the method as above, a bitwidth for the beam ID in the indication information is determined based on the number of beams in the configured set of beams.

In one embodiment, the method as above, a bitwidth for the beam ID in the beam information is determined based on the number of beams in the selected set of beams, the set of beams having the largest number of beams, or the configured set of beams.

In one embodiment, the method as above, a bitwidth for the set ID is determined based on the number of set of beams in the list corresponding to the selected set of beams, the number of set of beams in the list having the largest number of sets of beams, or the number of configured sets of beams.

In one embodiment, the method as above, a bitwidth for the list ID in the beam information is determined based on the number of lists.

In one embodiment, the method as above, the beam report comprises a first part with a fixed bitwidth and a second part with an unfixed bitwidth, the first part comprises at least one of: partial indication information, or none of or partial beam information, the second part comprises at least one of: the rest indication information, or the rest beam information, the partial indication information and the rest indication information do not overlap with each other and together constitute the indication information, the none of or partial beam information and the rest beam information do not overlap with each other and together constitute the beam information.

In one embodiment, the method as above, the second part comprises the beam ID in the beam information, and a bitwidth for the beam ID is determined based on the number of beams in the set of beams indicated by at least part of the indication information in the first part.

In one embodiment, the method as above, the second part comprises the beam ID in the indication information, and a bitwidth for the beam ID is determined based on the number of beams in the list indicated by the list ID in the first part.

In one embodiment, the method as above, the second part comprises the set ID, and a bitwidth for the set ID is determined based on the number of set of beams in the list indicated by the list ID in the first part.

In one embodiment, the method as above, the second part comprises the beam information, and the number of beams in the beam information in the second part is determined based on the number of beams in the set of beams indicated by at least part of the indication information in the first part.

In one embodiment, the method as above, the first part comprises the beam information and the second part comprises the beam information, the beam information in the first part comprises M1 quality metric(s) and the second part comprises M2 quality metric(s), wherein the sum of M1 and M2 is equal to M, which is the number of quality metrics in the beam information.

In one embodiment, the method as above, the value of the M1 is determined based on the number of beams in the set of beams having the least number of beams.

The present disclosure provides a method for communication, comprising: transmitting, at a network device to a terminal device, configuration information indicating a configured set of beams and one or more lists, a list of the one or more lists comprising one or more sets of beams being subsets of the configured set of beams, the one or more sets of beams and/or the configured set of beams being configured at the terminal device for an Artificial Intelligence/Machine Learning operation; and receiving, from the terminal device, a beam report comprising indication information and beam information associated with a set of beams selected from the one or more sets of beams, the indication information comprising at least one of: a list ID, a set ID or a beam ID associated with the selected set of beams.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results.

In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communication, comprising:
determining, at a terminal device, a configured set of beams and one or more lists, a list of the one or more lists comprising one or more sets of beams being subsets of the configured set of beams, the one or more sets of beams and/or the configured set of beams being configured for an Artificial Intelligence/Machine Learning (AI/ML) operation;
selecting a set of beams from the one or more sets of beams; and
transmitting, to the network device, a beam report comprising indication information and beam information corresponding to the selected set of beams, the indication information comprising at least one of: a list identifier (ID), a set ID or a beam ID corresponding to the selected set of beams, the beam information comprising at least one of: a beam ID or a quality metric corresponding to the selected set of beams.

2. The method of claim 1, wherein selecting the selected set of beams comprises:
determining one or more sets of quality metrics corresponding to the one or more sets of beams; and
selecting the selected set of beams based on the one or more sets of quality metrics and at least one criterion.

3. The method of claim 2, wherein the at least one criterion comprises at least one of the following first type of criteria:
a maximum of a set of quality metrics corresponding to the selected set of beams is maximum amongst the one or more sets of beams;
a minimum of the set of quality metrics corresponding to the selected set of beams is minimum amongst the one or more sets of beams;
a mean or a root mean square of the set of quality metrics corresponding to the selected set of beams is maximum or minimum amongst the one or more sets of beams;
a variance or a standard deviation of the set of quality metrics corresponding to the selected set of beams is minimum or maximum amongst the one or more sets of beams;
an error between the set of quality metrics and a set of reference quality metrics corresponding to the selected set of beams is minimum amongst the one or more sets of beams;
the set ID or the list ID corresponding to the selected set of beams is minimum or maximum amongst the one or more sets of beams; or
the number of beams in the selected set of beams is minimum or maximum amongst the one or more sets of beams.

4. The method of claim 2, wherein the at least one criterion comprises at least one of the following second type of criteria:
a maximum of a set of quality metrics corresponding to the selected set of beams is greater than or equal to a first threshold;
a minimum of the set of quality metrics corresponding to the selected set of beams is less than or equal to a second threshold;
a mean or a root mean square of the set of quality metrics corresponding to the selected set of beams is greater than or equal to a third threshold, or less than or equal to a fourth threshold;
a variance or a standard deviation of the set of quality metrics corresponding to the selected set of beams is less than or equal to a fifth threshold, or greater than or equal to a sixth threshold; or
an error between the set of quality metrics and a set of reference quality metrics corresponding to the selected set of beams is less than or equal to a seventh threshold.

5. The method of claim 4, wherein selecting the selected set of beams comprises:
determining, based on the one or more sets of quality metrics and the second type of criteria, whether a set of beams among the one or more sets of beams is to be selected as the selected set of beams sequentially in a predefined order.

6. The method of claim 5, wherein the predefined order is at least one of:
an ascending order or a descending order of set ID corresponding to the one or more sets of beams;
an ascending order or a descending order of list ID corresponding to the one or more sets of beams; or
an ascending order or a descending order of the number of beams in the one or more sets of beams.

7. The method of claim 4, further comprising:
in response to determining that none of the one or more sets of beams satisfies at least one of the second type of criteria, including beam information corresponding to the configured set of beams in the beam report.

8. The method of claim 7, wherein the beam report further comprises an indication indicating whether none of the one or more sets of beams satisfies the second type of criteria.

9. The method of claim 7, a number of zeros are padded in the fields corresponding to the indication information in the beam report.

10. The method of claim 1, wherein the beam ID in the indication information indicates a specific beam which is comprised in the selected set of beams but is not comprised in any other set of beams amongst the one or more sets of beams.

11. The method of claim 10, wherein the specific beam is at least one of:
a beam having the lowest or largest reference signal resource ID in the selected set of beams, or
a beam having the largest quality matric in the selected set of beams.

12. The method of claim 1, wherein the beam ID in the beam information indicates a beam having the largest quality metric in the selected set of beams.

13. The method of claim 1, the number of beams in the beam information is determined based on the number of beams in the selected set of beams or a set of beams.

14. The method of claim 1, a bitwidth for the beam ID in the indication information is determined based on the number of beams in the configured set of beams.

15. The method of claim 1, a bitwidth for the beam ID in the beam information is determined based on the number of beams in the selected set of beams, the set of beams having the largest number of beams, or the configured set of beams.

16. The method of claim 1, a bitwidth for the set ID is determined based on the number of set of beams in the list corresponding to the selected set of beams, the number of set of beams in the list having the largest number of sets of beams, or the number of configured sets of beams.

17. The method of claim 1, a bitwidth for the list ID in the beam information is determined based on the number of lists.

18. The method of claim 1, wherein the beam report comprises a first part with a fixed bitwidth and a second part with an unfixed bitwidth,
wherein the first part comprises at least one of: partial indication information, or none of or partial beam information, the second part comprises at least one of: the rest indication information, or the rest beam information, the partial indication information and the rest indication information do not overlap with each other and together constitute the indication information, the none of or partial beam information and the rest beam information do not overlap with each other and together constitute the beam information.

19. The method of claim 18, wherein the second part comprises the beam ID in the beam information, and a bitwidth for the beam ID is determined based on the number of beams in the set of beams indicated by at least part of the indication information in the first part.

20. The method of claim 18, wherein the second part comprises the beam ID in the indication information, and a bitwidth for the beam ID is determined based on the number of beams in the list indicated by the list ID in the first part.

21. The method of claim 18, wherein the second part comprises the set ID, and a bitwidth for the set ID is determined based on the number of set of beams in the list indicated by the list ID in the first part.

22. The method of claim 18, wherein the second part comprises the beam information, and the number of beams in the beam information in the second part is determined based on the number of beams in the set of beams indicated by at least part of the indication information in the first part.

23. The method of claim 18, wherein:
the first part comprises the beam information and the second part comprises the beam information,
the beam information in the first part comprises M1 quality metric(s) and the second part comprises M2 quality metric(s),
wherein the sum of M1 and M2 is equal to M, which is the number of quality metrics in the beam information.

24. The method of claim 23, wherein the value of the M1 is determined based on the number of beams in the set of beams having the least number of beams.

25. A method for communication, comprising:
transmitting, at a network device to a terminal device, configuration information indicating a configured set of beams and one or more lists, a list of the one or more lists comprising one or more sets of beams being subsets of the configured set of beams, the one or more sets of beams and/or the configured set of beams being configured at the terminal device for an Artificial Intelligence/Machine Learning (AI/ML) operation; and
receiving, from the terminal device, a beam report comprising indication information and beam information associated with a set of beams selected from the one or more sets of beams, the indication information comprising at least one of: a list identifier (ID), a set ID or a beam ID associated with the selected set of beams.

26. A terminal device comprising:
a processor; and
a memory storing computer program codes;
the memory and the computer program codes configured to, with the processor, cause the terminal device to perform the method of any of claims 1-24.

27. A network device comprising:
a processor; and
a memory storing computer program codes;
the memory and the computer program codes configured to, with the processor, cause the network device to perform the method of claim 25.

28. A computer readable medium having instructions stored thereon, the instructions, when executed by a processor of an apparatus, causing the apparatus to perform the method of any of claims 1-24 or claim 25.
